(19) United States
(12) Patent Application Publication
(10) Pub. No.: US 2004/0245421 A1
(43) Pub. Date: Dec. 9, 2004

(54) Method and device for holding boxes

(76) Inventor: Robert R. Turvey, Sanford, MI (US)

Correspondence Address: S.C. JOHNSON & SON, INC., 1525 HOWE STREET, RACINE, WI, 53403-2236, US

(21) Appl. No.: 10/457,151

(22) Filed: Jun. 9, 2003

(51) Int. Cl. F16B 45/00

(52) U.S. Cl. 248/304

(57) ABSTRACT

A holding device includes a backing member and first and second projections extending from the backing member for insertion into first and second objects. A divider may extend from the backing member between the first and second projections.

### TECHNICAL FIELD

The present invention relates to suspension devices, and more particularly to a device for holding boxes or other containers.

### BACKGROUND OF THE INVENTION

The use of boxes for the storage and dispensing of items, such as food and general household items including reclosable thermoplastic bags, is well known. Generally, such boxes can be characterized by shape, size, and contents therein. Often, the boxes are stacked loosely in a cabinet, drawer, or pantry on a shelf and jostled during the process of removing contents, thereby requiring a user to hold the box with one hand and pull the contents out with another.

Regardless of the type of box, a box that is loose on a shelf or in a drawer readily allows the contents of the box to spill or, in the alternative, is difficult to reach unless the box is carefully arranged and handled. In addition, many different types and sizes of boxes exist. When such boxes are placed together in a confined space, such as a cupboard, cabinet, drawer, shelf, refrigerator, or the like, a disorganized condition can develop, preventing a user from easily locating a particular box. Further, as a user is attempting to locate a particular box, the box may be jostled, thereby causing one or more containers to fall off a supporting surface to the floor, resulting in breakage of the container and/or the articles stored therein and/or spilling of contents. Also, the boxes are usually placed on top of one another, leading to an inefficient use of space and difficulty in reaching the contents therein. Still further, when boxes are stacked on top of each other in an unconfined location, the boxes tend to slide out of the stacked configuration and into a disorganized state.

Attempts have been made to address the foregoing problems through the use of holding devices that retain one or more boxes in a horizontal or vertical orientation, thereby maintaining the boxes in an organized condition for efficient dispensing.

Hy U.S. Pat. No. 2,155,760 discloses a box holder for mounting a box on a wall or other surface. The box holder comprises a rectangular hanger-like body having marginal flanges that stiffen the body and space it from the surface or wall. Upper blades extending in a downward direction and lower blades extending in an upward direction are mounted to the body and pierce the box for suspension therefrom.

Yaffa U.S. Pat. No. 2,315,573 discloses a bracket for holding cartons, wherein the bracket includes a shelf and prongs extending upwardly from the shelf. A carton is pushed down on the prongs until a bottom thereof rests on the shelf and the prongs are inside the carton.

Dube U.S. Pat. No. 3,110,467 discloses a hook for a facial tissue box. The hook is made of sheet metal and is capable of being attached to a surface. The hook includes a body having two spaced parallel slits disposed on sides thereof that define two prongs offset from the plane of the body. The prongs include pointed tips that pierce the box for suspension therefrom.

Schnabel U.S. Pat. No. 3,395,428 discloses an all purpose fastening clip for attaching objects to a fixed support. The clip includes a main body with a base extension for engaging a surface and an upcurved extension adapted to receive papers or other objects such as a box with a slit. The upcurved extension comprises a semi-loop that resiliently engages the main body.

Jones U.S. Pat. No. 4,176,817 discloses a releasable holder for boxes. The holder includes a base having end portions that project at right angles therefrom. A first end portion comprises pointed members for engaging a first side of a box. A second end portion includes an eccentric member rotatably mounted to the base. The eccentric member is rotated to cause a leveled edge thereof to move into engagement with a second side of the box, thereby securing the box between the end portions.

Jelen U.S. Pat. No. 4,304,382 discloses a device for mounting objects on a pegboard. Fasteners are inserted into holes of the pegboard to suspend items therefrom. The fasteners may have integrally formed means for retaining objects therein, wherein the fastener and retaining means may be fabricated from a single piece of sheet metal.

Lane U.S. Pat. No. 4,390,102 discloses a support unit for packaged convenience foods. The support unit includes an elongate standard having a plurality of holding members attached thereto to hang items therefrom. The holding members have reentry portions for engaging or impaling the package for convenience foods.

Chen U.S. Pat. No. 5,494,250 discloses a cleaning tissue holder for hanging on a wall. The tissue holder includes an upper wall having a horizontal portion and a curved forward portion extending therefrom. A pack of cleaning tissues is engaged between the upper wall and a resiliently-biased push plate.

Furukawa U.S. Patent Application Publication No. 2003/0025057 discloses a tissue case holder including a plate having two hooks with tip portions. The tip portions are adapted to be inserted into holes formed in first and second ends of the tissue case.

### SUMMARY OF THE INVENTION

In accordance with one aspect of the present invention, a holding device includes a backing member and first and second projections extending from the backing member for insertion into first and second objects.

In accordance with a further aspect of the present invention, a holding device includes a backing member and first and second projections extending from the backing member. The holding device further includes a divider extending from the backing member between the first and second projections.

In accordance with yet another aspect of the present invention, a combination includes a holding device including a backing member and first and second projections extending therefrom. The combination further includes a box having a first slot for receiving the first projection and a second box having a second slot for receiving the second projection.

In accordance with still another aspect of the present invention, a method for holding at least one object includes the step of attaching a holding device having a backing member, two projections, and a divider disposed between the two projections to a surface. The method further includes the steps of providing an object having an opening and inserting one of the projections into the opening.

In accordance with a further aspect of the present invention, a box includes panels forming an enclosure and edges formed by intersection of the panels. The box further includes a slot disposed parallel to and spaced between about 0.05 inch (1.27 mm) and about 1.0 inch (25.4 mm) from an edge of the box, wherein the slot has a thickness of between about 0.100 inch (2.54 mm) and about 0.150 inch (3.81 mm). Still further, the box includes an opening separate from the slot for removing product contained in the box.

In accordance with a still further aspect of the present invention, a box includes panels forming an enclosure and edges formed by intersection of the panels. The box further includes a slot disposed in a panel forming a side of the box parallel to and spaced between about 0.05 inch (1.27 mm) and about 1.0 inch (25.4 mm) from an edge of the box. Still further, the box includes an opening separate from the slot for removing product contained in the box.

In accordance with yet another aspect of the present invention, a combination includes a box having a removable product opening section. The combination further includes a holding device having a backing member and first and second projections extending from the backing member, wherein the holding device is disposed in the box.

Other aspects and advantages of the present invention will become apparent upon consideration of the following detailed description and the attached drawings, in which like elements are assigned like reference numerals.

### BRIEF DESCRIPTION OF THE DRAWINGS

FIG. 1 is an isometric view of a first embodiment of the present invention;

FIG. 2 is a rear elevational view of the embodiment of FIG. 1 with boxes suspended therefrom;

FIG. 2A is an isometric view of a box according to the present invention;

FIG. 3 is a sectional view taken generally along the lines 3-3 of FIG. 2;

FIG. 4 is a front elevational view of another embodiment of the present invention;

FIG. 5 is an isometric view of the embodiment of FIG. 4;

FIG. 6 is an isometric view of yet another embodiment of the present invention similar to that shown in FIG. 5;

FIG. 7 is a front elevational view of the embodiment of FIG. 6;

FIG. 8 is an isometric view of the embodiment of FIG. 5 with a box suspended therefrom;

FIG. 9 is an isometric view of still another embodiment of the present invention;

FIG. 10 is an isometric view of the embodiment of FIG. 9 with boxes held therein;

FIG. 11 is an isometric view of a further embodiment of the present invention; and

FIG. 12-15 are isometric views of other embodiments of the present invention.

### DESCRIPTION OF THE PREFERRED EMBODIMENT

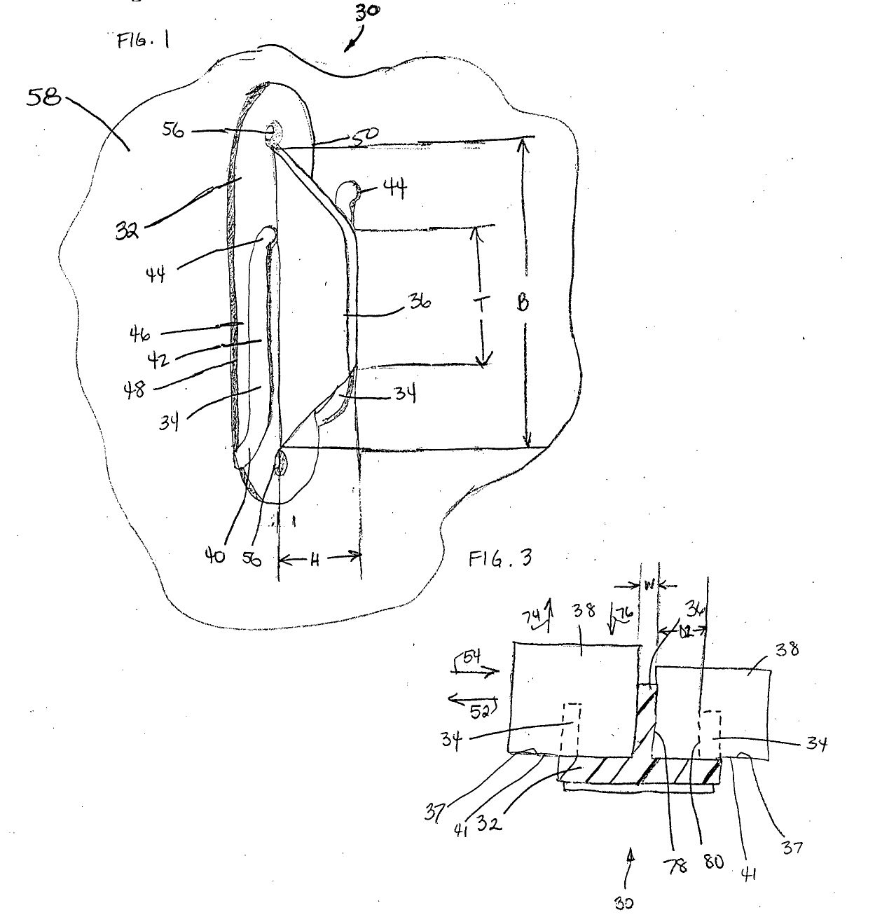

Referring to FIGS. 1-3, a holding device 30 includes an oval-shaped backing member 32, two arms or projections 34, and a divider 36. The holding device 30 is to be used to suspend, hang, or simply hold items in place and is used with any boxes 38 or other containers capable of dispensing an item therefrom. The holding device 30 is preferably constructed of thermoplastic material but other materials may be employed. Also, the backing member 32 may be of any other shape, such as polygonal (e.g., rectangular or square) or irregularly shaped.

The two arms 34 extend from the backing member 32 substantially normal thereto as does the divider 36. The divider 36 is disposed between the two arms 34. A user may position individual boxes 38 over each of the arms 34 such that the arms 34 extend through openings, such as slots (described in greater detail hereinafter) in the boxes 38 and engage inner surfaces 37 of walls 41 of the boxes 38.

Referring particularly to FIG. 1, the arms 34 extend from the backing member 32 and include a first portion 40 transverse to the backing member 32 and a curved portion 42 extending from the first portion 40 and spaced from the backing member 32. Each curved portion 42 includes a tapered lead-in portion 44 for insertion into a box 38. The arms 34 and the backing member 32 form a channel 46 therebetween. The channel 46 generally may have a width that is less than a thickness of the wall 41 of the box 38, thus causing an interference fit between the box 38, the respective arm 34, and the backing member 32. In this case, the interference fit is afforded by one or both of compression of the material of the box wall 41 and deflection of the respective arm 34. Optionally, the channel 46 may have a width that ranges from the same thickness as the wall 41 of the box 38 to much greater than the thickness of the wall 41 of the box 38.

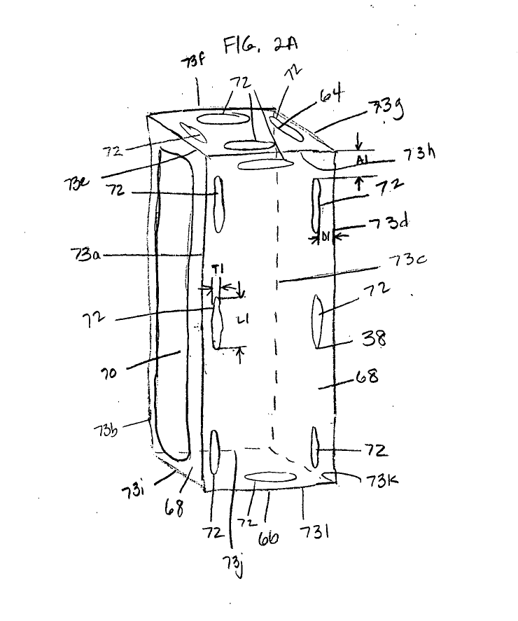

The divider 36 preferably extends perpendicularly from the backing member 32 and is preferably spaced equidistant from the first and second edges 48 and 50, respectively, of the backing member 32. The divider 36 is used to initially locate and aligned the box 38 therewith, so that a user can quickly and efficiently mount the boxes 38 on respective arms 34. The divider 36 is further provided to separate the boxes 38 and to limit substantial movement of the boxes 38 in first and second directions represented by arrows 52 and 54 (FIG. 3), respectively, when holding or suspending boxes from the arms 34, as noted in greater detail hereinafter. The divider 36 may have any width W, height H, base length B, or top length T suitable to separate the boxes 38 and prevent movement thereof. In the embodiment of FIGS. 1-3, the divider 36 has a base length B that is greater than the top length T, but the base length B and the top length T may be substantially equal or the top length T may be greater than the base length B. Also, the base length L and/or top length T may have a length substantially equal to a length of the backing member. The divider 36 preferably has a width W of between about 0.015 inch (0.381 mm) and about 0.2 inch (5.08 mm), more preferably between about 0.03 inch (0.762 mm) and about 0.1 inch (2.54 mm), and most preferably about 0.062 inch (mm). Further, the divider 36 preferably has a height H of between about 0.2 inch (5.08 mm) and about 2.0 inch (50.8 mm), more preferably between about 0.5 inch (12.7 mm) and about 1.0 inch (25.4 mm), and most preferably about 0.78 inch (19.812 mm). Still further, the divider 36 has at least a base length B (and preferably a top length T) of between about 1.0 inch (25.4 mm) and about 4.0 inch (101.6 mm), more preferably between about 2.0 inch (50.8 mm) and about 3.5 inch (88.9 mm), and most preferably about 2.78 inch (70.612 mm). The base and top lengths B and T may be different depending on a length of the holding device 30.

The backing member 32 preferably includes means for mounting the device 30. As seen in FIG. 1, the backing member 32 includes two mounting holes 56 that are adapted to accept fasteners for fastening the holding device 30 to a mounting surface 58 (FIG. 1), such as a wall, floor, drawer, or underside of a shelf, cabinet, pantry, closet, etc. The mounting holes 56 extend through the backing member 32 at top 60 and bottom 62 portions of the backing member 32. Other suitable means for fastening the holding device 30 to a surface include hook and loop (i.e., Velcro) fasteners, double sided tape (FIG. 3), an adhesive, or the like disposed between the backing member 32 and the mounting surface 58.

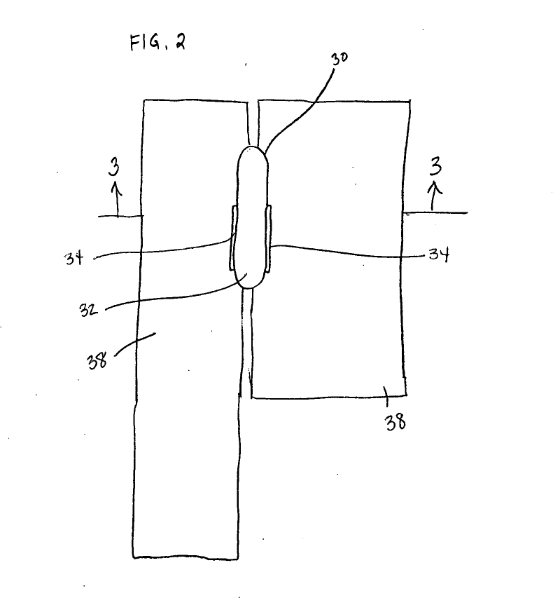

Each of the boxes 38 includes top and bottom panels 64 and 66, respectively, and four side panels 68, wherein at least one of the side panels 68 includes a product opening 70 for removing product from the boxes 38. Each box further includes at least one opening in the form of a slot 72 in at least one of the panels 64, 66, or 68. As seen in FIG. 2A, slots 72 can be formed almost anywhere in the box 38. For example, a slot 72 may be formed in any of the panels 64, 66, or 68, as long as the slot 72 is a distance D1 from an adjacent edge 73a-73l of the box 38 of between about 0.05 inch (1.27 mm) and about 1.25 inch (31.75 mm), more preferably from about 0.10 inch (2.54 mm) to about 0.5 inch (12.7 mm), and most preferably about 0.16 inch (4.064 mm). Any number of slots 72 may be included in a single box 38, but only one is necessary for use with the holding device 30. Preferably, each slot 72 has a length L1 from about 0.5 inch (12.7 mm) to about 1.5 inch (38.1 mm), more preferably from about 0.75 inch (19.05 mm) to about 1.25 inch (31.75 mm), and most preferably about 1.00 inch (25.4 mm). Also, each slot 72 preferably has a thicknesses T1 from about 0.100 inch (2.54 mm) to about 0.150 inch (3.81 mm), more preferably from about 0.112 inch (2.845 mm) to about 0.137 inch (3.48 mm), and most preferably about 0.12 inch (3.048 mm). Preferably, although not necessarily, the slots 72 are all spaced the same distance D1 from an adjacent edge 73d and/or the lengths L1 and thicknesses T1 of the slots 72 are substantially (but not necessarily) equal. The distance D1 is preferably between about 0.05 inch (1.27 mm) and about 1.0 inch (25.4 mm), more preferably between about 0.1 inch (2.54 mm) and about 0.4 inch (10.16 mm), and most preferably about 0.16 inch (4.064 mm). Preferably, although not necessarily, the slots 72 maybe be spaced a distance A1 from an adjacent edge 73h. The distance A1 is preferably between about 0.2 inch (5.08 mm) and about 6.0 inch (154.2 mm), more preferably between about 0.75 inch (19.05 mm) and about 1.5 inch (38.1 mm), and most preferably about 1.06 inch (26.924 mm). The distances D1 and A1 might be smaller or larger depending on the size of the box 38 to be supported by the holding device 30.

In operation and as seen in FIGS. 2 and 3, a user places one of the boxes 38 such that the tapered lead-in portion 44 of one of the arms 34 is inserted into a slot 72 and guides a panel 64, 66, or 68 of the box 38 in a downward direction over the arm 34 and into the channel 46. The width of the channel 46 may limit some movement of the box 38 in third and fourth directions 74 and 76 (FIG. 3), respectively, depending on the width thereof. Further, the distance D1 of the slot 72 from an adjacent edge 73 of the box 38 is preferably about the same distance as a distance D2 between an outer surface 78 of the divider 36 to an inner surface 80 of the arm 34. In this case, the divider 36 and the respective arms 34 create interferences with the box 38 and limit movement of the box 38 in the first and second directions 52 and 54, respectively. If preferred, the other box 38 is placed onto the holding device 30 in the same manner as the first box 38. To remove either of the boxes 38 from the holding device 30, the respective box 38 is pulled upwardly over the first portion 40 of the arm 34 and along the curved portion 42 until the panel 64, 66, or 68 containing the slot 72 is removed from the tapered lead-in portion 44 and the channel 46, whereupon the box 38 is disengaged from the holding device 30.

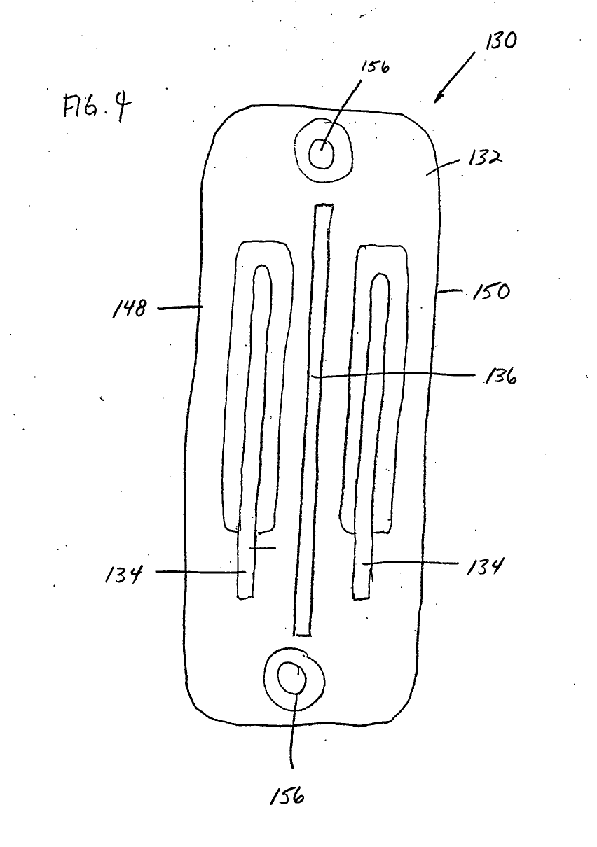

FIGS. 4 and 5 depict an embodiment of a holding device 30 similar to that of FIGS. 1-3. The holding device 30 includes a rectangular-shaped backing member 132, two arms 34, and a divider 36. The divider 36 is preferably spaced equidistant from first and second edges 48 and 50, respectively, of the backing member 34 and extends perpendicularly therefrom. The divider 36 of FIGS. 4 and 5 is different from that of FIGS. 1-3 in that the base length B and the outer length T are substantially equal. The arms 34 are also preferably spaced equidistant between the first and second edges 48 and 50, respectively, (48 and 50 have to be inserted into both of FIGS. 4 and 5) and the divider 36 and have the same basic features as the arms 34 of FIGS. 1-3. The holding device 30 of this embodiment preferably includes means for mounting the backing member 32, wherein mounting holes 56 are shown in FIGS. 4 and 5.

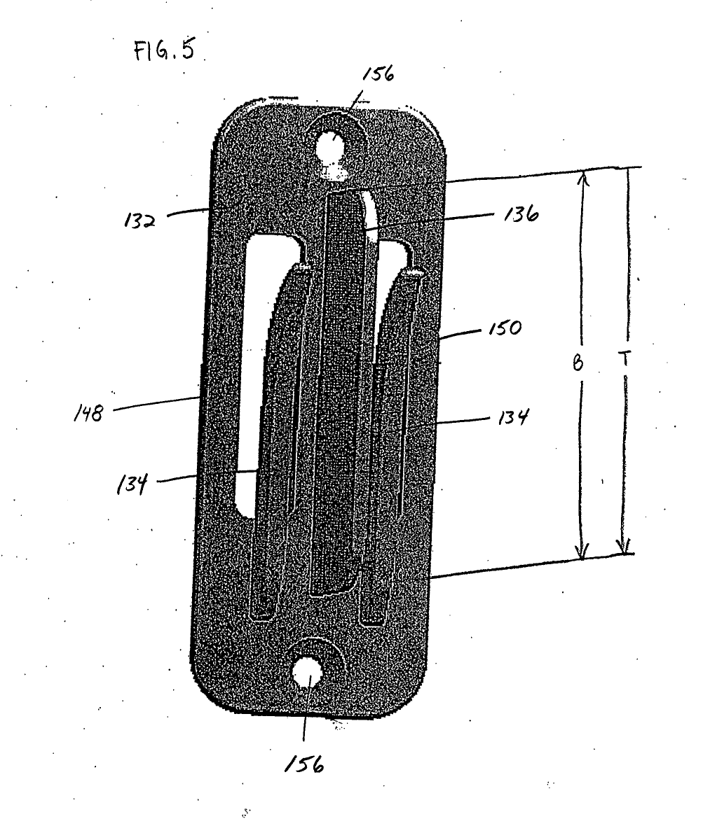

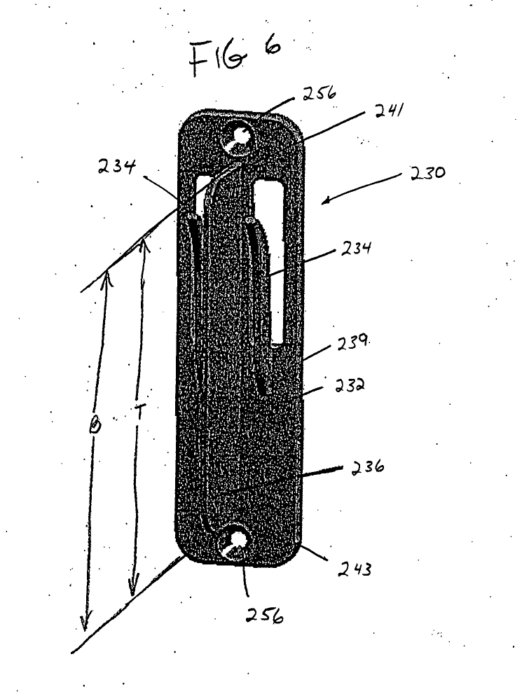

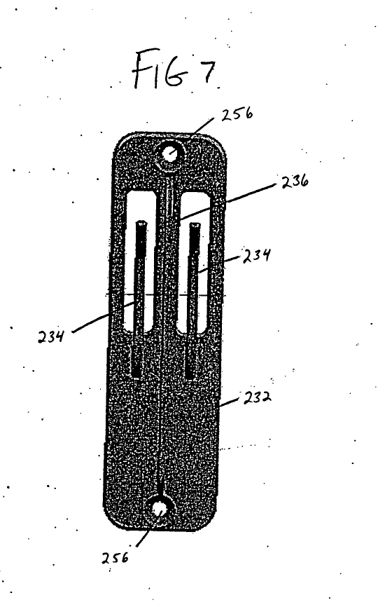

The embodiment of FIGS. 6-8 is similar to the embodiment of FIGS. 4 and 5, except that the arms 34 extend from a center portion 39 of the holding device 30. The arms 34 in any of the embodiments disclosed herein may be positioned at any point on the holding device 30 as long as a box 38 can be positioned thereon and removed therefrom. As with FIGS. 4 and 5, the base length B and the outer length T are relatively the same, but the base length B may instead be shorter or longer than the outer length T. The base length B preferably extends substantially completely between mounting holes 56 from an upper portion 41 to a lower portion 43 of the holding device 30, but may instead extend between any two portions of the holding device 30. Preferably, the holding device 30 includes any mounting means as discussed herein, but is shown with mounting holes 56.

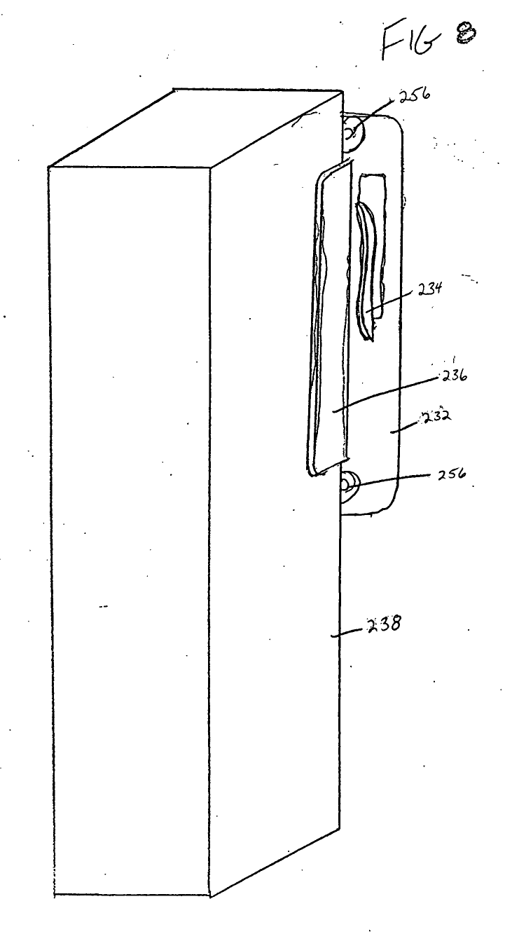

Like the embodiments described above, the holding device 130 as seen in FIGS. 9 and 10 includes a backing member 132, two arms 134 extending from the backing member 132, and a divider 136 extending perpendicularly from the backing member 130. The holding device 130 further includes a support wall 137 extending perpendicularly from the backing member 132 at an upper portion 141 or lower portion 143 thereof, wherein the support wall 137 is also substantially perpendicular to the divider 136. The arms 134 are in the form of hooks extending from the backing member 132 and are disposed on each side of the divider 136, wherein each of the arms 134 engages walls defining a single slot or other opening of a box 138. As discussed above, the divider 136 and the arms 134 create interferences with the box 138 to limit movement of a box 138 placed thereon in first and second directions denoted by arrows 152 and 154, respectively, in FIG. 9. The support wall 137 in combination with each of the arms 134 prevent movement of a box in fifth and sixth directions indicated by arrows 180 and 182, respectively.

Each arm 134 in the embodiment of FIGS. 9 and 10 includes a first straight portion 184 extending perpendicularly from the backing member 132. The first straight portion 184 terminates in a second triangular head portion 186 that forms a hook portion which interferes with removal of a box therefrom. Each arm 134 is preferably spaced equidistant between the divider 136 and a respective edge 133 and 135 of the device 130. Each arm 134 is spaced a distance substantially equal to the distance between a slot 172 formed in a box 138a and an side panel 168 of the box 138a. In operation and as seen in FIG. 10, a user places the box 138a such that the triangular head portion 186 of one of the arms 134 is inserted into the slot 172 of the box 138a and guides the box 138a in a downward direction over the first straight portion of the arm 134, thus fully engaging the box 138a with the arm 134. Engagement of the box 138a with the arm 134 somewhat limits movement of the box 138a in third and fourth directions represented by arrows 174 and 176, respectively, although the straight portion 184 of the arm 134 will allow some movement of the box 138a on the arm. If a user prefers, a second box 138b may thereafter be placed on the other arm 134 in the same manner as the first box 138a. To remove either of the boxes 138 from the holding device 130, the respective box 138 is pulled upwardly over the straight portion 184 and the box 138 is torn around the slot to remove it from the triangular head portion 186.

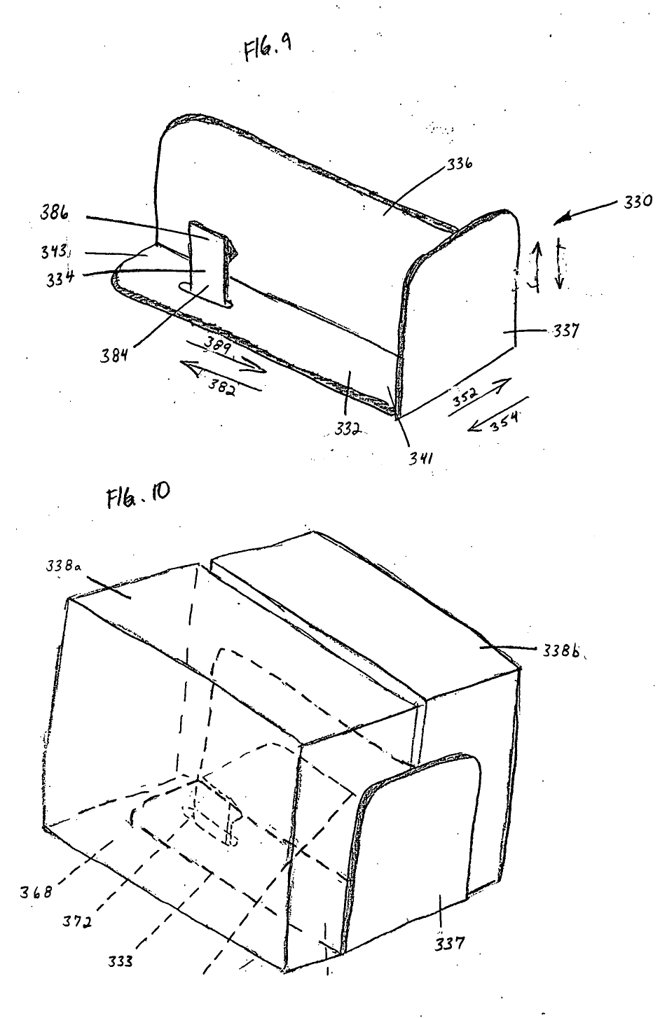

As discussed in detail above, the embodiment of FIGS. 9 and 10 may also include means for mounting the backing member 132 of the holding device 130 on any surface. Such means include mounting holes (for example, as seen in FIG. 11, which embodiment is otherwise substantially identical to the embodiment of FIGS. 9 and 10) with corresponding fasteners, hook and loop (i.e. Velcro) fasteners, double sided adhesive tape, an adhesive, or the like.

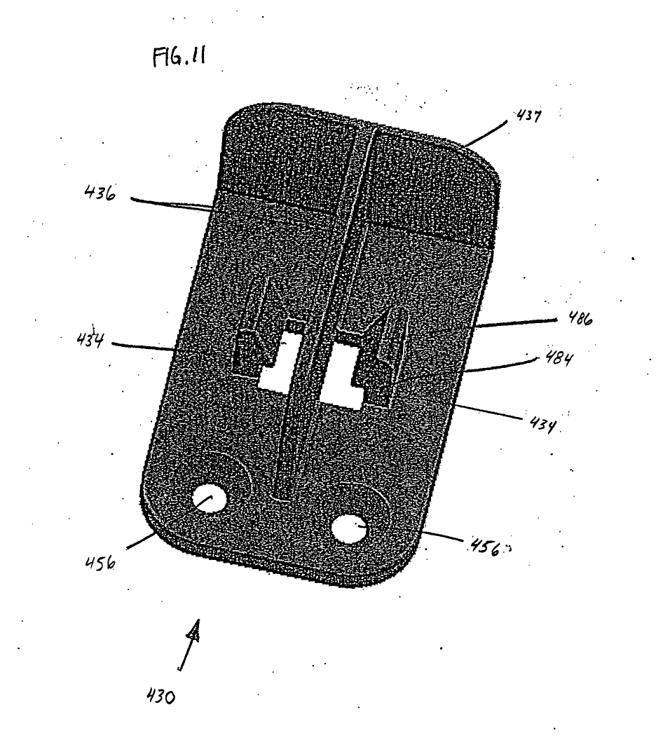

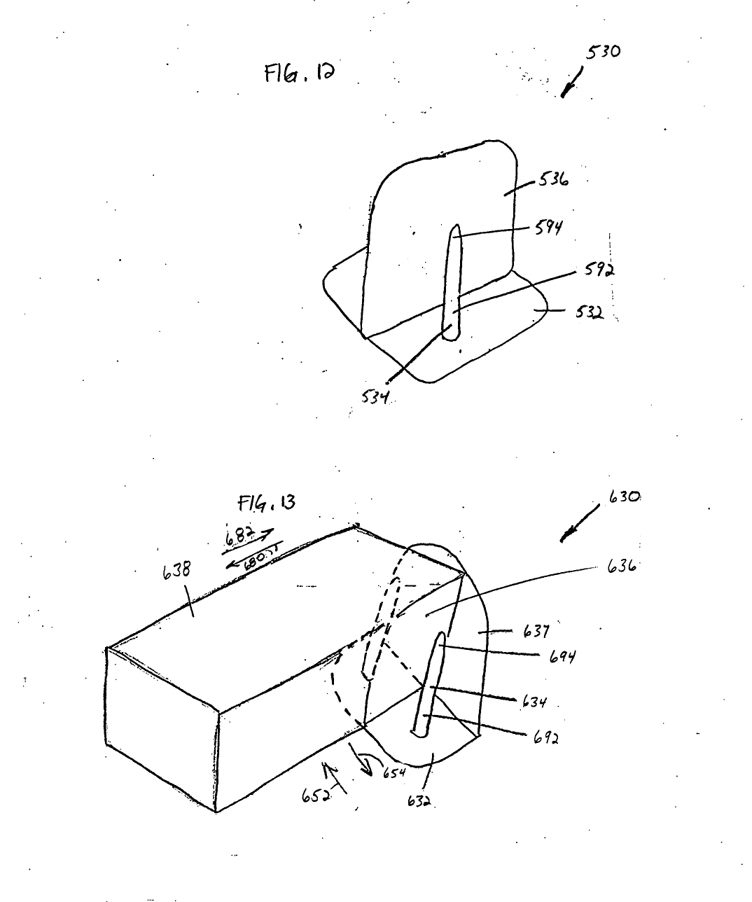

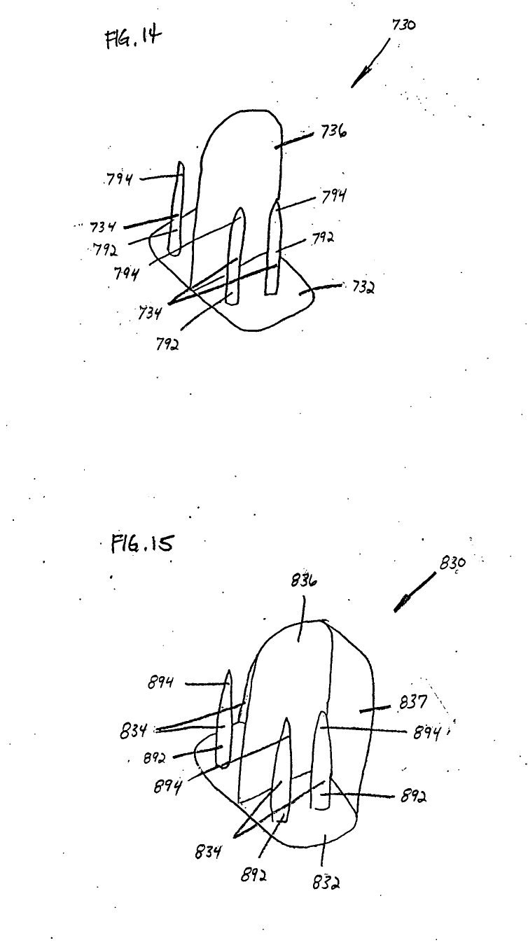

As seen in FIGS. 12-15, alternative embodiments of the present invention comprise a smaller holding device 230. Each of the embodiments of FIGS. 12-15 includes a backing member 232, a divider 236 extending perpendicularly from the backing member 232, and at least one arm 234 disposed on each side of the divider 236 and extending perpendicularly from the backing member 232. Each of the arms 234 includes a first straight and cylindrical portion 292 that terminates in a sharp protrusion 294. The arms 234 may also be any polygonal shape including, but not limited to, rectangular, square, or oval-shaped in cross-section. As seen in FIGS. 12 and 13, one arm 234 is disposed on each side of the divider 236 each for engaging a box 238 (seen in FIG. 13). The embodiments of FIGS. 14 and 15 depict a holding device 230 with two arms 234 disposed on each side of the divider 236 for engagement with a box. Any number of arms 234 may be used in such embodiments, but one or two arms 234 on each side of the divider 236 is preferred. As seen in FIGS. 13 and 14, the holding device 230 may also include a support wall 237 extending perpendicularly from the backing member 232 and forming a right angle with the divider 236.

During use, a user places a box 238 such that the sharp protrusion 294 of one of the arms 234 or set of arms 234 pierces the box 238 and guides the box 238 in a downward direction over the cylindrical portion 292 of the arm 234, thus fully engaging the box 238 with the arm 234. When the box 238 is engaged with the arm(s) 234, the divider 236 prevents movement of the box 238 in first and second directions represented by arrows 252 and 254, respectively. If a support wall 237 is included, the support wall 237 in combination with the arm(s) 234 prevent movement of the box 238 in fifth and sixth directions represented by arrows 280 and 282, respectively. If preferred, a second box 238 may thereafter be placed on the other arm(s) 234 in the same manner. To remove a box 238 from the holding device 230, the respective box 238 is pulled upwardly over the straight cylindrical portion 292 and the sharp protrusion 294, whereupon the box 238 is disengaged from the holding device 230.

Any of the embodiments of FIGS. 12-15 may include means for mounting the backing member 232 of the holding device 230 on any surface. As in the previous embodiments, such means include mounting holes with corresponding fasteners, hook and loop (i.e. Velcro) fasteners, double sided adhesive tape, an adhesive or the like.

### INDUSTRIAL APPLICABILITY

As should be evident, one may use single or ganged multiple holding devices that are secured to a vertical support surface, a horizontal support surface or a non-horizontal and non-vertical support surface in any configuration and/or orientation desired by the user so that the boxes are maintained in a desired arrangement, including side by side or vertically stacked. Thus, the boxes are arranged for efficient dispensing of product therefrom.

The holding device of the present invention can be made from any suitable rigid material such as plastic, glass, metal, wood and similar substances. The only important features of the materials of construction are that they be relatively rigid, inexpensive, and can be readily formed into a desired shape. Suitable plastic materials include polypropylene, polyethylene, styrene, nylon, and a wide variety of other similar homopolymers and copolymer materials. Any suitable molding technique can be used to form these devices, including injection molding and thermoforming.

The holding device allows a user to address a variety of home storage problems. First, the holding device enables a user to store and organize boxes to fully utilize available storage space. For example, in a closet, pantry, cabinet, or the like the present invention allows a user to hang boxes from the underside of a surface, thus freeing up the shelf surface space for the storage of other items. The holding device may also be used in a horizontal orientation, such as in a drawer, thus organizing the drawer and allowing full use of drawer space.

As should be evident, the holding device of the present invention may be of any suitable shape, such as polygonal (triangular, pentagonal, hexagonal, etc.), circular, regular, or irregular shape. The holding device may be packaged in the box in combination with the product stored therein, or the holding device may be separately provided, as desired. Fastening means, such as a section of double-sided adhesive tape, screws, hook and loop fasteners, etc. may also be provided in the box or may be provided separately, as desired.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out the same. The exclusive rights to all modifications which come within the scope of the appended claims are reserved.

1. A holding device, comprising:
a backing member;
first and second projections extending from and immovable with respect to the backing member for insertion into first and second objects; and
a divider extending from the backing member wherein the divider is disposed between and spaced from the first and second projections.

2. The holding device of claim 1, wherein each projection includes a first portion transverse to the backing member.

3. The holding device of claim 2, wherein each projection includes a curved portion extending from the first portion and spaced from the backing member.

4. The holding device of claim 3, wherein each curved portion includes a tapered lead-in portion.

5. The holding device of claim 2, wherein the projections and backing member form two channels.

6. The holding device of claim 5, wherein each of the channels comprises a closed end and an open end and wherein the open ends receive a portion of a box.

7. The holding device of claim 1, wherein each projection includes a straight portion perpendicular to the backing member.

8. The holding device of claim 7, wherein each projection includes a triangular-shaped portion extending from the straight portion and wherein each triangular-shaped portion retains an object thereon.

9. The holding device of claim 7, wherein each projection includes a sharp end for piercing a hole in a box.

10. The holding device of claim 1, wherein the device is made of plastic.

11. The holding device of claim 1, wherein the backing member includes at least one mounting hole for accepting a fastener.

12. The holding device of claim 1, wherein the backing member includes double sided adhesive tape on a back surface thereof.

13. The holding device of claim 1, wherein the backing member has a polygonal shape.

14. The holding device of claim 13, wherein the backing member has a rectangular shape.

15. A holding device, comprising:
a backing member;
a divider extending from and immovable with respect to the backing member; and
at least two projections extending from and immovable with respect to the backing member for selectively engaging walls defining openings of first and second different objects wherein the divider is disposed between and spaced from the projections.

16. The holding device of claim 15, wherein the at least two projections are parallel to one another.

17. The holding device of claim 16, wherein the divider extends perpendicularly from the backing member.

18. The holding device of claim 17, wherein the divider is parallel to the at least two projections.

19. The holding device of claim 18, wherein the at least two projections are inserted into first and second boxes, respectively.

20. The holding device of claim 19, wherein the divider prevents movement of the first and second boxes in first and second directions.

21. The holding device of claim 18, wherein each projection includes a first portion transverse to the backing member.

22. The holding device of claim 21, wherein each projection includes a curved portion extending from the first portion and spaced from the backing member.

23. The holding device of claim 22, wherein each curved portion includes a tapered lead-in portion.

24. The holding device of claim 11, wherein the projections and backing member form two channels.

25. The holding device of claim 24, wherein each of the channels comprises a closed end and an open end and wherein the open ends receive a portion of a box.

26. The holding device of claim 18, wherein each projection includes a straight portion perpendicular to the backing member.

27. The holding device of claim 26, wherein each projection includes a triangular-shaped portion extending from the straight portion and wherein the triangular-shaped portion retains an object thereon.

28. The holding device of claim 26, wherein each projection includes a sharp end for piercing a hole in a box.

29. The holding device of claim 18, wherein the device is made of plastic.

30. The holding device of claim 18, wherein the backing member includes at least one mounting hole for accepting a fastener.

31. The holding device of claim 18, wherein the backing member includes double sided adhesive tape on a back surface thereof.

32. The holding device of claim 18, wherein the backing member has a polygonal shape.

33. The holding device of claim 32, wherein the backing member has a rectangular shape.

34. The holding device of claim 18, wherein the backing member is attached to a vertical surface.

35. The holding device of claim 18, wherein the backing member is attached to a horizontal surface.

36. The holding device of claim 18, further including a support wall extending perpendicularly from the backing member.

37. The holding device of claim 36, wherein the support wall is perpendicular to the divider.

38. The holding device of claim 37, wherein first and second boxes are inserted onto the first and second projections, respectively.

39. The holding device of claim 38, wherein the support wall and projections prevent movement of the boxes in third and fourth directions.

40. A combination, comprising:
a holding device including a backing member and first and second projections extending therefrom on opposite sides of and spaced from a divider wherein the backing member, the first and second projections, and the divider are immovable with respect to one another;
a first box having a first slot for receiving the first projection; and
a second box having a second slot for receiving the second projection.

41. The combination of claim 40, wherein each projection includes a tapered lead-in portion capable of insertion into the slots.

42. The combination of claim 41, wherein the projections further include main portions transverse to the backing member and the tapered lead-in portions.

43. The combination of claim 40, wherein the device is made of plastic.

44. The combination of claim 40, wherein the backing member includes at least one mounting hole for accepting a fastener.

45. The combination of claim 40, wherein the backing member includes double sided adhesive tape on a back surface thereof.

46. The combination of claim 40, wherein at least one of the boxes includes disposable bags.

47. A method for holding at least one object, the method comprising the steps of:
attaching a holding device to a surface wherein the holding device includes a backing member, two projections, and a divider and wherein the backing member, projections, and divider are immovable with respect to one another and the divider is disposed between and spaced from the two projections;
providing an object having an opening; and
inserting one of the projections into the opening.

48. The method of claim 47, further including the step of providing a second object having a further opening.

49. The method of claim 48, further including the step of inserting the other of the projections into the further opening.

50. The method of claim 47, wherein each projection includes a first portion transverse to the backing member.

51. The method of claim 50, wherein each projection further includes a curved portion extending from the first portion and spaced from the backing member.

52. The method of claim 51, wherein each curved portion includes a tapered lead-in portion.

53. The method of claim 47, wherein the backing member includes at least one mounting hole for accepting a fastener.

54. The method of claim 47, wherein the backing member has a polygonal shape.

55. The method of claim 54, wherein the backing member has a substantially rectangular shape.

56. The method of claim 47, wherein the device is made out of plastic.

57. A box, comprising:
panels forming an enclosure;
edges formed at intersections of the panels;
first and second slots each disposed parallel to and spaced between about 0.05 inch (1.27 mm) and about 1.0 inch (25.4 mm) from an edge of the box, wherein each of the first and second slots has a thickness of between about 0.100 inch (2.54 mm) and about 0.150 inch (3.81 mm) and wherein the first slot is disposed in a first panel and the second slot is disposed in a second panel adjacent the first panel; and
an opening separate from the first and second slots for removing product contained in the box.

58. The box of claim 57, wherein the box contains thermoplastic bags.

59. The box of claim 57, wherein the box contains thermoplastic wrap.

60. The box of claim 57, wherein the box contains aluminum foil.

61. The box of claim 57, wherein the box is made of cardboard.

62. The box of claim 57, wherein each of the first and second slots is spaced about 0.16 inch (4.064 mm) from an edge of the box.

63. The box of claim 57, wherein the box includes a plurality of slots each disposed parallel to and spaced between about 0.05 inch (1.27 mm) and about 1.0 inch (25.4 mm) from respective edges of the box.

64. The box of claim 57, wherein each of the first and second slots has a thickness of between about 0.12 inch (3.048 mm).

65. A box, comprising:
panels forming an enclosure;
edges formed at intersections of the panels;
first and second slots disposed in first and second different adjacent panels, respectively, wherein each of the first and second slots is parallel to and spaced between 0.05 inch (1.27 mm) and about 1.0 inch (25.4 mm) from an edge of the box; and
an opening separate from the first and second slots for removing product contained in the box.

66. The box of claim 65, wherein the box contains thermoplastic bags.

67. The box of claim 65, wherein the box contains thermoplastic wrap.

68. The box of claim 65, wherein the box contains aluminum foil.

69. The box of claim 65, wherein the box is made of cardboard.

70. The box of claim 65, wherein each of the first and second slots is spaced about 0.16 inch (4.064 mm) from an edge of the box.

71. The box of claim 65, wherein the box includes a plurality of slots each disposed parallel to and spaced between about 0.05 inch (1.27 mm) and about 1.0 inch (25.4 mm) from respective edges of the box.

72. The box of claim 65, wherein each of the first and second slots has a thickness of about 0.12 inch (3.048 mm).

73. A combination, comprising:
a first box having a removable product opening section, a second box having a removable product opening section; and
a holding device having a backing member, a divider, and first and second projections extending from and immovable with respect to the backing member, wherein one of the projections is disposed in the first box and the other projection is disposed in the second box.

74. The combination of claim 73, wherein the box further includes at least one slot disposed in a panel forming a side of the box.

75. (canceled)
